(19) United States
(12) Patent Application Publication
(10) Pub. No.: US 2008/0025729 A1
(43) Pub. Date: Jan. 31, 2008

(54) Optical transceiver precisely setting the transmission rate of the output optical signal

(75) Inventor: Tomoyuki Funada, Kanagawa (JP)

Correspondence Address: VENABLE LLP, P.O. BOX 34385, WASHINGTON, DC, 20043-9998, US

(73) Assignee: Sumitomo Electric Industries, Ltd., Osaka (JP)

(21) Appl. No.: 11/878,629

(22) Filed: Jul. 25, 2007

(30) Foreign Application Priority Data
Jul. 27, 2006 (JP) 2006-204872

(51) Int. Cl. H04B 1/38

(52) U.S. Cl. 398/136; 398/195

(57) ABSTRACT

The present invention is to provide an optical transceiver that enhances and keeps the exactness of the transmission rate of the optical signal to be transmitted. The transceiver includes a rate adjustor, where the de-stuffing unit, the FIFO memory and the stuffing unit. The input electrical data are temporarily stored in FIFO memory synchronized with the clock extracted from the input data. The stored data are read out by the clock highly stabilized by the voltage controlled oscillator (VCO). The control signal for the VCO is compensated to the temperature.

### FIELD OF THE INVENTION

The present invention relates to an optical transceiver, in particular, to an optical transceiver with a function to set the transmission rate thereof precisely.

### RELATED PRIOR ART

In the 10 Gigabit-Ethernet protocol, the 10 GBASE-W that rules the physical layer for the wide area network (WAN) is standardized in addition to the 10 GBASE-R that relates to the physical layer for the local area network (LAN). The 10 GBASE-R defines the transmission rate to be 10.3125±100 ppm, while, the 10 GBASE-W rules the rate to be 10.3125±20 ppm, which is quite stricter to that of the 10 GBASE-R. To secure the exactness of the transmission rate by ±20 ppm at the end of the life of the transceiver, twice of the strictness of the transmission rate, namely, ±10 ppm, is necessary at the beginning of the life.

In order to enhance the exactness of the transmission rate for the transceiver, a conventional method is to set up the data signal from the input electrical signal with an accuracy of ±100 ppm by the clock signal with relatively superior accuracy, and is to convert thus formatted electrical signal into an optical signal. However, the crystal oscillator to generate the clock signal inherently accompanies with temperature instability; accordingly, the clock frequency fluctuates when the temperature within the transceiver is risen, which degrades the exactness of the optical transmission rate. Thus, it is unable to keep the superior exactness such as within ±10 ppm.

The present invention is to provide a configuration of the optical transceiver that enables to show and keep the exactness of the transmission rate.

### SUMMARY OF THE INVENTION

The optical transmitter according to the present invention, which is installed within an optical transceiver, includes a rate adjustor, an electrical-to-optical converter, a voltage-controlled oscillator, and a compensating unit. The rate adjustor receives a reference clock and an input electrical data to output an output data that synchronizes with the reference clock. The electrical-to-optical converter converts the output data sent from the rate adjustor into an optical data to output this optical data. The voltage-controlled oscillator (VCO) outputs the reference clock that is controlled by a control signal set in the VCO. The compensating unit, which includes a temperature sensor to sense a temperature of the VCO, outputs the control signal so as to compensate the temperature dependence of the output frequency of the VCO. Accordingly, the output optical data maybe precisely compensated in temperature, and the exactness of the transmission rate within +10 ppm can be achieved.

The optical transmitter may further include a clock extractor in the rate adjustor, a comparing unit comprising a phase comparator, a low-pass filter and a selector. The clock extractor extracts a data clock from the input data. The phase comparator compares a phase of the data clock and a phase of the reference clock. The low-pass filter integrates an output of the phase comparator. The selector chooses one of outputs of the low-pass filter and the compensating unit, and outputs the chosen data to the VCO as the control signal. Thus, when the selector chooses the output of the low-pass filter, the VCO, the phase comparator, the low-pass filter may constitute a phase-locked-loop circuit and the optical data output from the electrical-to-optical converter may fully synchronize with the input electrical data.

The optical transceiver that installs the optical transmitter of the present invention further includes an optical receiver that receives an optical input data and outputs an electrical output data corresponding to the optical input data. According to the invention, the optical transceiver may further includes a clock extractor that extracts a data clock from the electrical data output from the optical receiver, a phase comparator that compares a phase of the data clock and a phase of the reference clock, a low-pass filter to integrate an output of the phase comparator, and a selector to choose one of outputs of the low-pass filter and the compensating unit and to output a chosen data to the VCO as the control signal. Thus, when the selector chooses the output of the low-pass filter, the VCO, the phase comparator, the low-pass filter may constitute a phase-locked-loop circuit and optical data output from the electrical-to-optical converter may fully synchronize with the optical data input to the optical receiver.

### BRIEF DESCRIPTION OF DRAWINGS

FIG. 1 is a block diagram of an optical transceiver according to the first embodiment of the invention;

FIG. 2 is a block diagram of the rate adjustor shown in FIG. 1;

FIG. 3 illustrates behaviors of various crystal oscillators against the temperature;

FIG. 4 shows the behavior of the oscillation frequency of the voltage controlled oscillator against the control signal;

FIG. 5 shows a block diagram of another optical transceiver according to the second embodiment of the invention; and

FIG. 6 shows a block diagram of still another optical transceiver according to the third embodiment of the invention.

### DESCRIPTION OF PREFERRED EMBODIMENTS

Next, preferred embodiments of the present invention will be described as referring to accompanying drawings. In the description of the drawings, the same numerals or symbols will refer to the same elements without overlapping explanations.

### First Embodiment

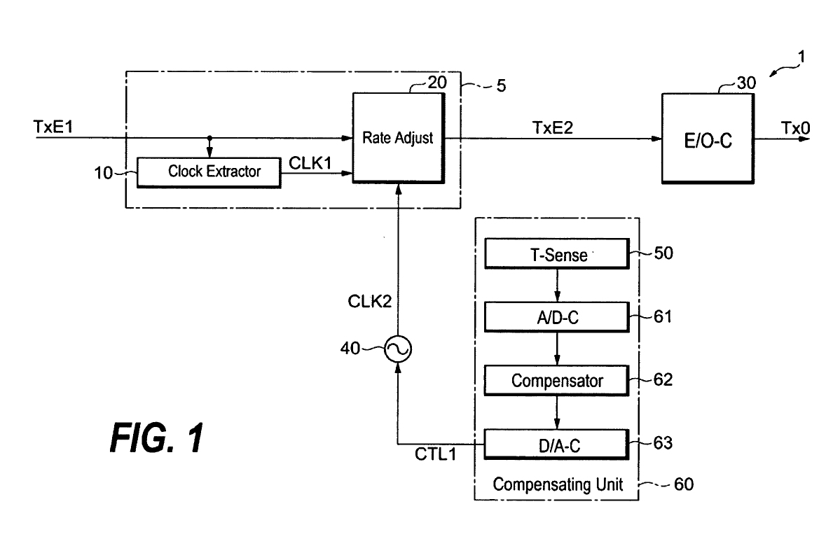

FIG. 1 is a block diagram of an optical transceiver according to the first embodiment of the present invention. The optical transceiver shown in FIG. 1 provides a pre-processor 5, an electrical-to-optical converter 30, a voltage controlled oscillator (hereafter denoted as VCO), and a compensating unit 60. FIG. 1 only illustrates the transmitter of the optical transceiver, and omits the receiver.

The pre-processor 5 may compensate the fluctuation of the transmission rate of the electrical signal TxE1 sent from the outside of the transceiver 1. The pre-processor 5 includes the clock extractor 10 and the rate adjustor 20, both of which receive the external signal TxE1.

The clock extractor 10 extracts the clock CLK1 from the external signal TxE1 and outputs the data clock CLK1 to the rate adjustor 20. When the external signal ExE1 obeys the 10 Gigabit-Ethernet standards, the transmission rate of the signal TxE1 in the rate thereof is necessary to be 10.3125 Gbps ±100 ppm, that is, the transmission rate of the external signal TxE1 and the data clock CLK1 have an accuracy of ±100 ppm. The “accuracy” means an offset from the center rate 10.3125 Gbps or the center frequency 10.3125 GHz.

The rate adjustor 20 also receives the reference clock CLK2 output from the VCO 40. The rate adjustor 20 may enhance the accuracy of the transmission rate of the external signal TxE1 by (1) sampling this external signal TxE1 with the data clock CLK1, (2) storing the sampled data, and (3) outputting the sampled data synchronized with the reference clock CLK2. Details of the operation in the rate adjustor will be described later.

The output of rate adjustor 20 is provided to the electrical-to-optical converter (hereafter denoted as E/O—C) 30. The E/O—C 30 is configured to convert the electrical signal TxE2 output from the rate adjustor 20 to an optical signal TxO and to emit this optical signal TxO outside. The E/O—C 30 includes a semiconductor laser diode, a laser driver, an auto-power control circuit and some optical systems to guide the emission TxO from the laser diode to the outside of the transceiver.

The VCO 40 generates the reference clock CLK2 and provides it to the rate adjustor 20. The control signal CTL1 supplied to the VCO from the compensating unit 60 may determine the frequency of the reference clock CLK2.

The compensating unit 60, by providing the control signal CTL1 to the VCO 40, may control the output frequency of the VCO 40, namely, the frequency of the reference clock CLK2. The control signal CTL1 is necessary to reflect the ambient temperature; accordingly, the compensating unit 60 includes the temperature sensor 50, the analog-to-digital converter (hereafter denoted as A/D-C) 61, the compensator 62 and the digital-to-analog converter (hereafter denoted as D/A-C) 63.

The temperature sensor 50 monitors the ambient temperature, in particular, a temperature of the VCO 40, and outputs a signal reflecting thus monitored temperature to the A/D-C 61. Generally, the temperature sensor 50 may be a thermistor.

The A/D-C 61 converts the analog signal output from the temperature sensor 50 to a corresponding digital signal and provides this digital signal to the compensator 62. The compensator 62 generates a control signal based on thus received digital signal, where the signal generated in the compensator 62 reflects the output frequency of the VCO 40, that is, the signal output from the compensator 62 may be determined so as to reduce the fluctuation in the output frequency of the VCO 40, which depends on the temperature of the VCO 40. Thus determined signal is provided to the D/A-C 63 to convert to the analog signal that is led to the VCO 40 to determine the frequency of the reference clock CLK2.

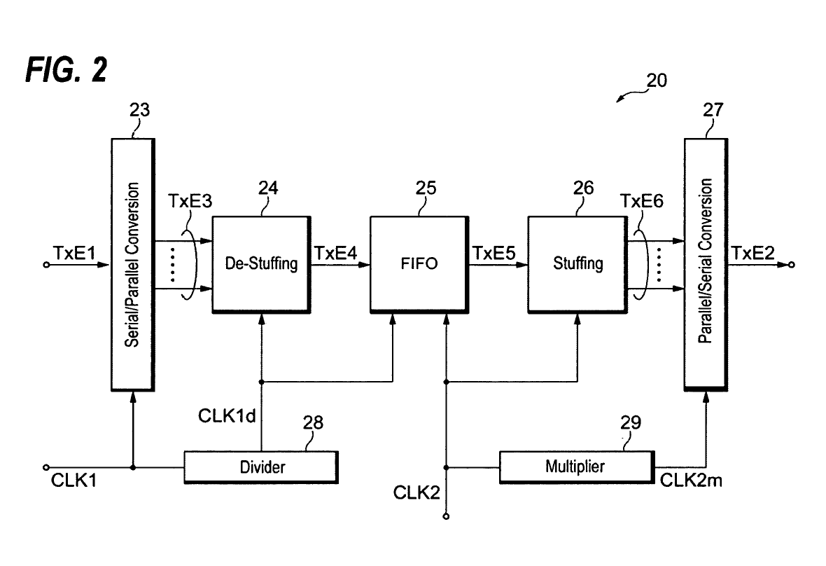

Next, the rate adjustor 20 will be explained in detail. FIG. 2 illustrates a block diagram of the rate adjustor 20. The rate adjustor 20 include a serial-to-parallel converter (hereafter denoted as S/P—C) 23, a de-stuffing unit 24, a first-in-first-out memory (hereafter denoted as FIFO memory) 25, a stuffing unit 26, a parallel-to-serial converter (hereafter denoted as P/S—C) 27, a clock divider 28, and a clock multiplier 29.

The S/P—C 23 receives the data signal TxE1 and the data clock CLK1 extracted by the clock extractor 10. The S/P—C 23 converts the signal TxE1, which is a serial data signal, into a parallel data TxE3 by the data clock CLK1 and sends thus converted parallel data TxE3 to the de-stuffing unit 24. To use the data clock CLK1 in the S/P—C 23 is to prevent the bit intermittence at the conversion by synchronizing the conversion clock fully with the signal to be converted.

The clock divider 28 divides the data clock CLK1 to generate a write clock CLK1d. When the rate adjustor 20 handles the digital data by the bit width of n, where n is an integer equal to or greater than 2, the dividing ratio of the clock divider 28 becomes 1/n. The write clock CLK1d has the accuracy in the frequency thereof within ±100 ppm, which is the same with that of the data clock CLK1. This clock divider 28 outputs the write clock CLK1d to the de-stuffing unit 24 and the FIFO memory 25.

The de-stuffing unit 24 temporarily stores the parallel data TxE3 in a temporary memory provided within the de-stuffing unit 24 after the stuffed bit is removed from the original parallel data TxE3, thus, the unit 24 is called as the de-stuffing unit 24. Then, the de-stuffing unit 24 reads the parallel data TxE3 stored in the temporary memory by the write clock CLK1d and sends thus read parallel data TxE4 to the FIFO memory 25. The de-stuffing unit 24 uses the write clock CLK1d to read the parallel unit TxE3 without any error.

The FIFO memory 25 provides a terminal to receive the reference clock CLK2. The FIFO memory 25 stores the parallel data TxE4 sent from the de-stuffing unit 25 synchronized with the write clock CLK1d. The stored data is sequentially read out synchronized with the reference clock CLK2. Thus, a plurality of parallel data TxE2 is sequentially output from the FIFO memory 25 to the stuffing unit 26. The write clock CLK1d is used to write the parallel data TxE4 in the FIFO memory 25 without error, while, the reference clock CLK2 is used for reading out the data from the FIFO 25, where the reference clock CLK2 has the accuracy superior to that of the write clock CLK1d. Thus, the transmission rate of the output data TxE2 can enhance the accuracy thereof compared to that of the input data TxE1.

The stuffing unit 26 also receives the reference clock CLK2. The stuffing unit 26 temporarily holds the input parallel data TxE2 from the FIFO memory 25 into the temporary memory within the stuffing unit 26, reads out the parallel data stored in the temporary memory and adds the stuffing bit, and outputs thus rearranged parallel data TxE6 to the P/S—C 27. Because the stuffing unit 28 uses the reference clock CLK2, not the write clock CLK1d, the output parallel data TxE6 shows the transmission rate with the excellent accuracy compared to the input data TxE1.

The de-stuffing unit 24 and the stuffing unit 26 are provided to compensate situations that the lack of memory allocation in the FIFO 25 and the lack of the data to be stored in the FIFO 25 even when two clocks for the FIFO memory 25, namely, the writing clock CLK1d and the reading clock CLK2, are different from each other. The de-stuffing unit 24 removes the stuffed bits, which is added to synchronize the data precisely with the clock rate ruled by the standard, from the input data. Accordingly, this unit 24 is called as the de-stuffing unit. While, the stuffing unit 26 stuffs additional bits to synchronize the data from the FIFO memory 25 fully with the predetermined clock rate, thus, the unit 26 is called as the stuffing unit.

The clock multiplier 29 configured to receive the reference clock CLK2, to multiply this reference clock CLK2 and to output thus multiplied clock CLK2m to the P/S—C 27. When the bit width of the data in the rate adjustor 20 is n, the multiplying ratio becomes n. The accuracy of the multiplied clock CLK2m is comparable with that of the reference clock CLK2.

The P/S—C 27 converts the input data TxE6, which is the n-bits parallel data, into a serial data TxE2 by the multiplied clock CLK2m. To use the multiplied clock CLK2m, which has the accuracy comparable to the reference clock CLK2, enhances the accuracy of the transmission rate of the output data TxE2 compared to that of the input data TxE1.

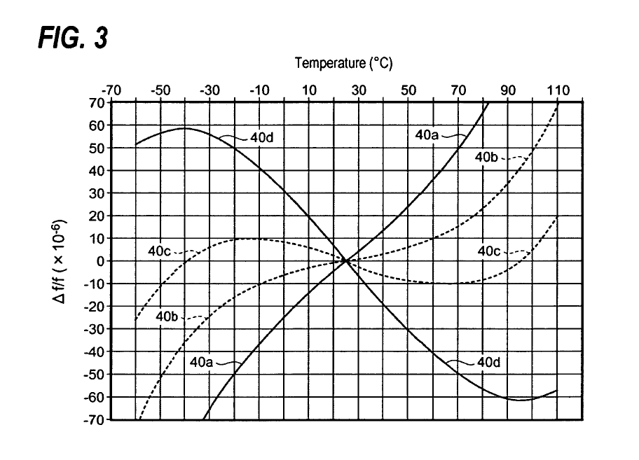

The present embodiment uses, as the VCO, a crystal oscillator that generally shows temperature dependence in the oscillation frequency thereof. When the control signal CTL1 is kept constant, the oscillation frequency of the crystal oscillator depends on the ambient temperature thereof. FIG. 3 illustrates the temperature dependence, 40a to 40d, of the oscillation frequency of the crystal oscillator generally available in the field. The horizontal axis shows the ambient temperature, while, the vertical axis corresponds to a deviation Δf of the oscillation frequency from the frequency f at the temperature 25° C. According to FIG. 3, an oscillator shown in the curve 40a increases the oscillation frequency by about 50 ppm when the ambient temperature increases from 25° C. to 70° C.

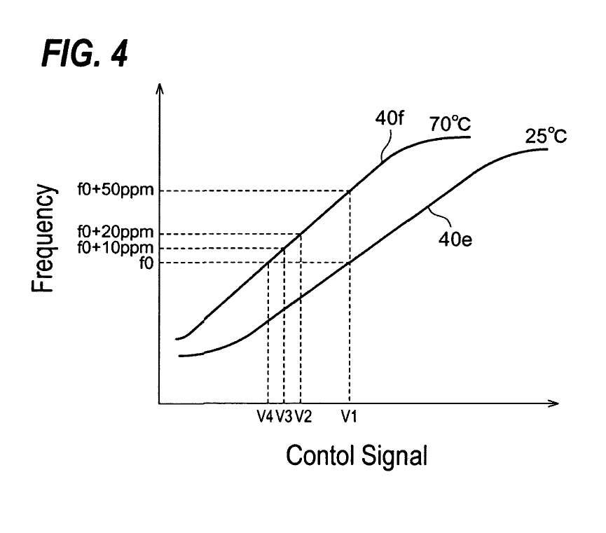

FIG. 4 shows behaviors of the oscillation frequency of the VCO 40 against the control signal CTL1 applied to the crystal oscillator. FIG. 4 includes two behaviors, 40f and 40e, corresponding to the ambient temperature of 25° C. and 70° C., respectively, for the crystal oscillator with the temperature dependence 40a appeared in FIG. 3. The horizontal axis corresponds to the control signal CTL1, while, the vertical axis shows the oscillation frequency.

The present embodiment, to reduce the frequency fluctuation of the reference clock CLK2, adjusts the control signal CTL1 depending on the variation of the ambient temperature of the VCO 40. As shown in FIG. 4, when the ambient temperature rises from 25° C. to 70° C. at the control signal CTL1 of V1, the deviation in the oscillation frequency maybe reduced from +50 ppm to +20 ppm by adjusting the control signal CTL1 from V1 to V2. Moreover, the deviation may be reduced to +10 ppm when the control signal CTL1 is decreased to V3, and the deviation in the oscillation frequency becomes substantially zero when the control signal CTL1 is reduced to V4.

The compensator 62, based on the temperature information sent from the A/D-C 61 and the characteristic of the VCO 40, in particular, the oscillation frequency thereof, may set the output thereof so as to suppress the frequency deviation of the reference clock CLK2. The output of the compensator 62 may be determined such that a variable corresponding to the ambient temperature may be substituted into a characteristic function derived from the behavior of the crystal oscillator shown in FIG. 3, or, a look-up-table maybe created in advance to the practical operation, in which the relation between the ambient temperature to the oscillation frequency is stored. The compensator 62 may output the control signal by fetching the control data corresponding to the present temperature, which is sent from the A/D-C 61, from the look-up-table. In an alternative procedure, the compensator 62 may set the control signal by the PID, PD or PI control.

Thus, because the frequency of the reference clock CLK2 may be adjusted based on the temperature of the VCO 40, the temperature dependence of the VCO 40 maybe compensated, and accordingly, the frequency fluctuation of the reference clock CLK2 may be reduced. The accuracy of the reference clock CLK2 initially set at the operation of the transceiver may be maintained independent on the ambient temperature. The optical transceiver outputs the transmission data TxO fully synchronized with the reference clock CLK2, thus, the fluctuation in the transmission rate of the optical output data TxO may be reduced within +10 ppm.

### Second Embodiment

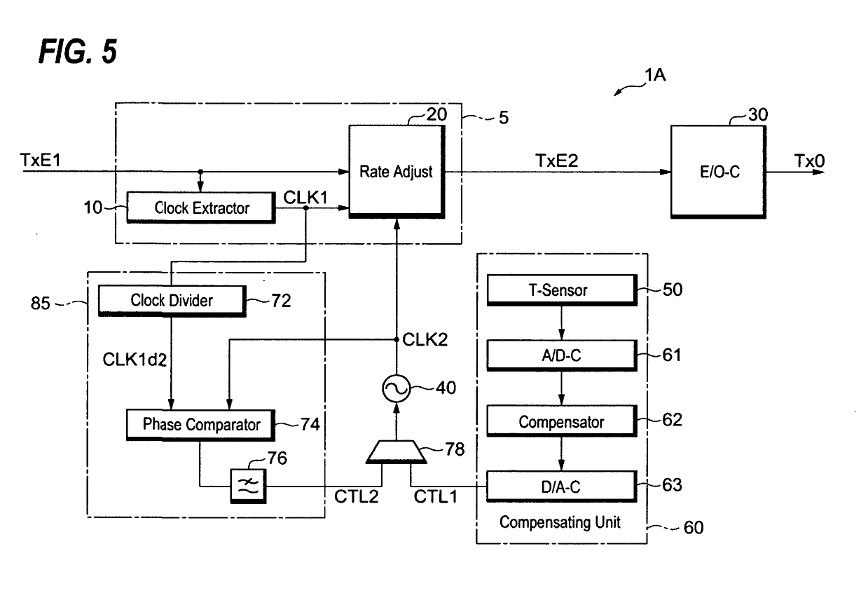

FIG. 5 is a block diagram of an optical transceiver according to the second embodiment of the invention. The transceiver 1A shown in FIG. 5 provides, in addition to the blocks of the first transceiver shown in FIG. 1, the comparing unit 85 and a selector 78. The comparing unit 85 in this embodiment includes the divider 72 and the low-pass filter (hereafter denoted as LPF) 76 in addition to the phase comparator 85.

The clock divider 72 divides the data CLK1 to generate the divided clock CLK1d2. Similar to the clock divider 28 in the rate adjustor 20, the dividing ratio of the clock divider 72 becomes 1/n when the data bit width is n. The clock divider 72 outputs the divided clock CLK1d2 to one of input terminals of the phase comparator 74.

Because the present embodiment correlates the frequency of the reference clock CLK2 to the bit width within the rate adjustor 20, the frequency of the divided clock CLK1d2 becomes equal to that of the reference clock CLK2, which enables the phase comparator 74 to compare two phases with high accuracy. Because data clock CLK1 provided from the clock extractor 10 is an overtone of the reference clock 2, enough accuracy may be obtained even when the clock divider 72 is omitted.

Another input of the phase comparator 74 receives the reference clock CLK2. Thus, the phase comparator 74 compares the phase of the divided clock CLK2D with the reference clock CLK2 and outputs a pulsed signal derived from the phase difference of these two clocks, CLK1d2 and CLK2, to the LPF 76.

The LPF 76 integrates this pulsed signal and sends the integrated signal to the selector 78 as the second control signal CTL2.

The selector 78 receives the first control signal CTL1 output from the compensating unit 60 and the second control signal CTL2 from the LPF 76, and outputs one of these control signals, CTL2 or CTL2, to the VCO 40. The selection of the control signals may be controlled by a signal provided from the outside of the transceiver 1.

When the selector 78 selects the first control signal CTL1 to the VCO 40, the configuration shown in FIG. 5 is substantially same with those shown in FIG. 1. While, when the selector 78 selects the second control signal CTL2 to output the VCO 40, a phase-locked-loop (hereafter denoted as PLL) may be constituted, which includes the clock divider 72, the phase comparator 74, the LPF 76, and the VCO 40. In this situation, the reference clock CLK2 fully synchronizes with the input data TxE1, that is, the optical output data TxO synchronizes with the input electrical data TxE1. Thus, the present embodiment may switch the operation modes, one of which may reduce the deviation in the transmission rate of the optical output data TxO, while the other of which synchronizes the optical output data TxO with the input electrical signal TxE1.

### Third Embodiment

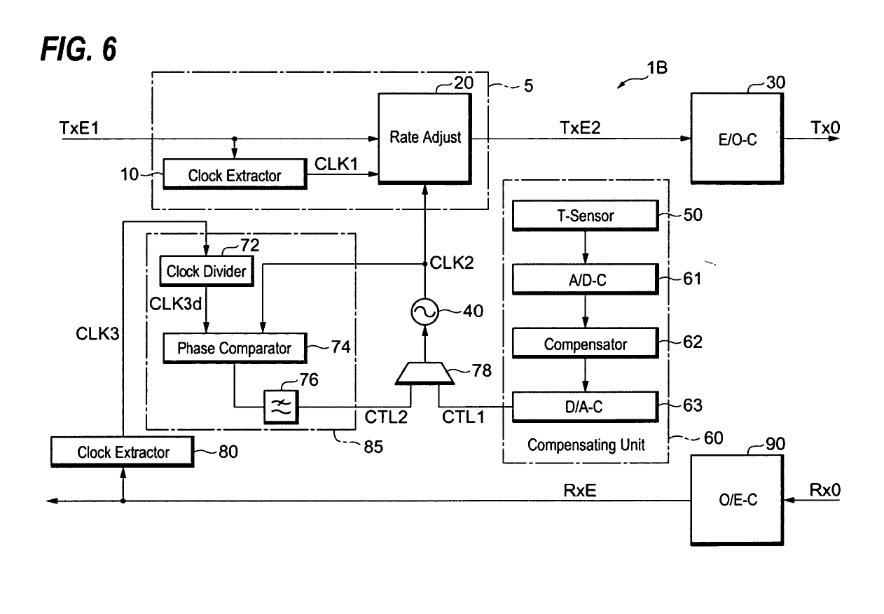

FIG. 6 illustrates a block diagram of an optical transceiver according to the third embodiment of the invention. FIG. 6 illustrates the optical-to-electrical conversion (hereafter denoted as O/E-C) block included within in an optical receiver, which is omitted in FIGS. 1 and 5. The optical transceiver 1B shown in FIG. 6 provides another clock extractor 80, in addition to the transceiver 1A in FIG. 5, and leads the output of this clock extractor 80 to the clock divider 72 in the comparing unit 85. Other units in FIG. 6 are same with those of the transceiver 1A shown in FIG. 5.

The O/E-C 90 converts the optical signal RxO input thereto into an electrical signal RxE. The clock extractor 80 extracts the data clock CLK3 involved within the received data RxE and outputs the data clock CLK3 to the clock divider 72 in the comparing unit 85. The clock divider 72 divides this data clock CLK3 to generate the divided clock CLK3d. The phase comparator 74 compares this divided clock CLK3d with the reference clock CLK2 and generates a pulsed signal corresponding to the phase difference of these two clocks, CLK3d and CLK2. This pulsed signal is integrated by the LPF 66 to generate the second control signal CTL2 output to the selector 78.

When the selector 78 chooses the first control signal CTL1 from the compensating unit 60 to the VCO 40, the same function as those of the first embodiment shows. While, in the case that the selector 78 selects the second control signal CTL2 from the LPF 78 to the VCO 40, the comparing unit 85 and the VCO 40 may constitute a PLL. Accordingly, the reference clock CLK2 may fully synchronize with the receiving signal RxO, and the transmitting optical signal TxO maybe also synchronized with the receiving signal RxO because the transmitting signal TxO is driven by the reference clock CLK2.

Thus, the present embodiment may select two modes, one of which may secure the accuracy of the transmission rate of the optical output data TxO, and the other may fully synchronize the optical transmitting data TxO with the receiving optical data RxO. When the transceiver 1B enters the loop-test mode where the transceiver receives the optical signal transmitted from the transceiver itself by directly coupling the E/0-C 30 with the o/E-C 90, the transmitting signal TxO is necessary to synchronize with the receiving signal RxO. The configuration shown in FIG. 6 may easily perform this loop-back test.

Thus, optical transceivers that precisely set the transmission rate of the output optical signal are disclosed. However, the specific embodiments described herein are merely illustrative. Numerous modifications in form and detail may be made without departing from the scope of the invention as claimed below. The invention is limited only by the scope of the appended claims.

I claim:

1. An optical transmitter, comprising:
a rate adjustor configured to receive a reference clock and an input data and to output an output data synchronized with the reference clock;
an electrical-to-optical converter configured to receive the output data from the rate adjustor, to convert the output data into a corresponding optical data and to output the optical data;
a voltage-controlled oscillator configured to output the reference clock with a frequency controlled by a control signal; and
a compensating unit including a temperature sensor to sense a temperature of the voltage-controlled oscillator, the compensating unit outputting the control signal based on the temperature sensed by the temperature sensor,
wherein the frequency of the reference clock output from the voltage-controlled-oscillator is compensated for the temperature.

2. The optical transmitter according to claim 1,
wherein the voltage-controlled-oscillator includes a crystal oscillator whose output with the frequency becomes the reference clock, the oscillation frequency of the crystal oscillator being compensated by the control signal.

3. The optical transmitter according to claim 2,
wherein a deviation in the output frequency of the crystal oscillator is within ±10 ppm.

4. The optical transmitter according to claim 2,
wherein the compensating unit includes a look-up-table that stores a relation between the temperature and the control signal.

5. The optical transmitter according to claim 1,
wherein the rate adjustor includes a clock extractor for extracting a data clock from the input data, a memory to store the input data synchronizing with the data clock and to output the stored input data synchronizing with the reference clock.

6. The optical transmitter according to claim 1,
wherein the rate adjustor includes a clock extractor for extracting a data clock from the input data,
wherein the optical transmitter further comprises a comparing unit including a phase comparator, a low-pass filter and a selector, the phase comparator comparing a phase of the extracted clock with a phase of the reference clock, a low-pass filter integrating an output of the phase comparator, and a selector configured to choose one of an output of the low-pass filter and the compensating unit and to output the chosen data to the voltage-controlled oscillator, and
wherein the phase comparator, the low-pass filter, the selector and the voltage-controlled oscillator constitute a phase-locked-loop circuit when the selector chooses the output of the low-pass filter.

7. An optical transceiver, comprising:
an optical transmitter to receive an electrical input data and to output an optical data corresponding to the electrical data, the optical transmitter including
a rate adjustor configured to receive a reference clock and the electrical input data and to output an output electrical data synchronized with the reference clock,
an electrical-to-optical converter configured to receive the output electrical data from the rate adjustor, to convert the output electrical data into a corresponding optical data and to output the optical data,
a voltage-controlled oscillator configured to output the reference clock controlled by a control signal, and
a compensating including a temperature sensor to sense the temperature of the voltage-controlled oscillator, the compensating unit outputting the control signal with a frequency depending on the temperature sensed by the temperature sensor; and
an optical receiver to receive an optical input data and to output an electrical output data corresponding to the optical input data,
wherein the control signal applied to the voltage-controlled-oscillator depends on an output of the temperature sensor.

8. The optical transceiver according to claim 7,
wherein the rate adjustor includes a clock extractor for extracting a data clock from the electrical output data, and
wherein the optical transceiver further includes a comparing unit including a phase comparator, a low-pass filter and a selector, the phase comparator comparing a phase of the extracted data clock with a phase of the reference clock, a low-pass filter integrating an output of the phase comparator, and a selector configured to choose one of an output of the low-pass filter and the compensating unit and to output the chosen data to the voltage-controlled oscillator as the control signal,
wherein the phase comparator, the low-pass filter, the selector and the voltage-controlled oscillator constitutes a phase-locked-loop circuit when the selector chooses the output of the low-pass filter, and the optical data output from the optical transmitter fully synchronizes with the optical input data received by the optical receiver.
